(19) United States
(12) Patent Application Publication
(10) Pub. No.: US 2026/0180161 A1
(43) Pub. Date: Jun. 25, 2026

(54) LOW-FREQUENCY RED-LIGHT THERAPY LAMP

(71) Applicant: Zhenyu Liu, Shenzhen (CN)

(72) Inventor: Zhenyu Liu, Shenzhen (CN)

(21) Appl. No.: 19/540,622

(22) Filed: Feb. 14, 2026

(51) Int. Cl. H01Q 1/36; F21V 8/00

(52) U.S. Cl. CPC H01Q 1/36; G02B 6/0068

(57) ABSTRACT

A low-frequency red-light therapy lamp is provided. The therapy lamp includes a quadrangular pyramid and a base fixedly connected to the quadrangular pyramid. The base is formed by embedding and connecting a first structural member with a downward opening and a second structural member with an upward opening, and the first structural member is formed by splicing a third structural member and a spiral PCB antenna board. An inner bottom circumference of the second structural member is annularly provided with an LED string. The quadrangular pyramid includes a first side wall, a second side wall, a third side wall, and a fourth side wall. Linear grooves are carved on the first side wall, the second side wall, the third side wall, and the fourth side wall.

### TECHNICAL FIELD

The present disclosure relates to the technical field of lamps, in particular to a low-frequency red-light therapy lamp.

### BACKGROUND

Currently, a light source generally used in the field of red-light sleep assistance is a conventional light source, and is similar to a small night lamp type, for example, a wearable phototherapy sleep relief apparatus in U.S. Ser. No. 11/672,943B2 or U.S. Pat. No. 1,086,180B2.

A small night lamp is proposed in a patent application document U.S. Ser. No. 11/672,943B2. Because a light emitting body of the small night lamp has an angle and can only be illuminated upward, light is unbalanced in an environment, and there is no prominent sense experience in a vision. A wearable phototherapy sleep relief apparatus is proposed in a patent application document U.S. Pat. No. 10,286,180B2. The apparatus may fail to fall when a user turns over when sleeping and lies on a side, and cause eye discomfort of the user after waking up in the morning.

Therefore, there is an urgent need for a light-emitting therapy lamp that is easy to use for a user and that is balanced for light emission.

### SUMMARY

An objective of the present disclosure is to provide a low-frequency red-light therapy lamp to solve the foregoing problem. For details, refer to the following description.

To achieve the above purpose, the present disclosure adopts the following technical solution:

A low-frequency red-light therapy lamp is provided in the present disclosure, the therapy lamp includes a quadrangular pyramid and a base fixedly connected to the quadrangular pyramid; the base is formed by embedding and connecting a first structural member with a downward opening and a second structural member with an upward opening, and the first structural member is formed by splicing a third structural member and a spiral PCB antenna board; an inner bottom circumference of the second structural member is annularly provided with an LED string;

the quadrangular pyramid includes a first side wall, a second side wall, a third side wall, and a fourth side wall; the first side wall, the second side wall, the third side wall, and the fourth side wall are connected in pairs, and every two adjacent side walls are disposed at an included angle and encircle the quadrangular pyramid with a hollow interior and a quadrangular top; and linear grooves are carved on the first side wall, the second side wall, the third side wall, and the fourth side wall.

Preferably, a single-chip microcomputer, an amplifier, and a spiral antenna are disposed in the spiral PCB antenna board; and the single-chip microcomputer is configured to generate electromagnetic waves, the amplifier is configured to amplify the electromagnetic waves, and the spiral antenna is configured to transmit the electromagnetic waves.

Preferably, the third structural member includes a first cuboid with a downward opening and a circular hollow hole in a top; and the second structural member includes a second cuboid with an upward opening.

Preferably, a cross-sectional area size of the first cuboid is less than that of the second cuboid.

Preferably, a fourth structural member is further fixedly disposed at an outer bottom of the second structural member; and the fourth structural member includes a third cuboid with an upward opening.

Preferably, a cross-sectional area size of the third cuboid is less than that of the second cuboid.

Preferably, a wavelength range of a luminescence spectrum of the LED string is 620 nm to 750 nm.

The low-frequency red-light therapy lamp is proposed in the present disclosure. The spiral PCB antenna board is embedded in the base, where the spiral PCB antenna board is configured to generate and transmit low-frequency electromagnetic waves. The low-frequency electromagnetic waves and terrestrial magnetism affect sleep through mechanisms such as frequency synchronization, melatonin secretion, heart rate variability, and circadian rhythm anchoring. In addition, the low-frequency electromagnetic waves are similar to α/θ wave frequency of a brain, which can promote sleep and deep sleep of a user and reduces night awakening. In addition, light is irradiated from a bottom edge of the quadrangular pyramid by using the LED string, and a refraction effect is generated when light passes through the carved grooves on the quadrangular pyramid, so that a stereo linear light source is presented, the whole light source of the therapy lamp is balanced and protrudes in an environment in which the whole light source is located, and a dazzling degree of a point light source for visual sensation is weakened.

### BRIEF DESCRIPTION OF THE DRAWINGS

In order to illustrate technical solutions in the embodiment of the present disclosure or in the prior art more clearly, accompanying drawings needing to be used in the embodiment or in the description in the prior art are simply described. Apparently, the embodiments in the following description are merely a part rather than all of the embodiments of the present disclosure. For any person skilled in the art, under the premise of without contributing creative labor, other accompanying drawings further can be obtained based on these accompanying drawings.

FIG. 1 is an exploded view of a low-frequency red-light therapy lamp according to the present disclosure;

FIG. 2 is an overall structure diagram of a low-frequency red-light therapy lamp according to the present disclosure;

FIG. 3 is a structure diagram of a second structural member of a low-frequency red-light therapy lamp according to the present disclosure;

FIG. 4 is a structure diagram of a first structural member of a low-frequency red-light therapy lamp according to the present disclosure;

FIG. 5 is a top view of a low-frequency red-light therapy lamp according to the present disclosure; and

FIG. 6 is a bottom view of a low-frequency red-light therapy lamp according to the present disclosure.

Reference numerals in accompanying drawings:
11: quadrangular pyramid; 12: first structural member; 13: second structural member; 14: third structural member; 15: spiral PCB antenna board; 16: LED string; 17: fourth structural member; 111: first side wall; 112: second side wall; 113: third side wall; and 114: fourth side wall.

### DETAILED DESCRIPTION OF THE EMBODIMENTS

In order to make objectives, technical solutions and advantages of the present disclosure clearer, the technical solutions of the present disclosure are described in detail as follows. Apparently, the embodiments in the following description are merely a part rather than all of the embodiments of the present disclosure. Based on the embodiment in the present disclosure, all other embodiments obtained by the ordinary technical staff in the art under the premise of without contributing creative labor belong to the scope protected by the present disclosure.

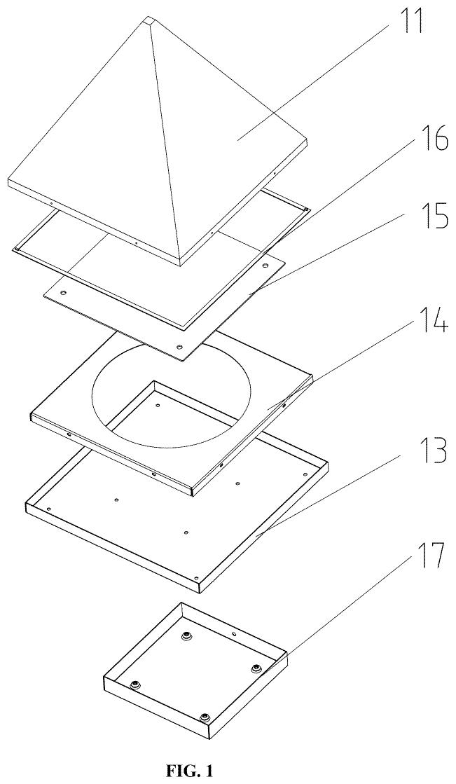

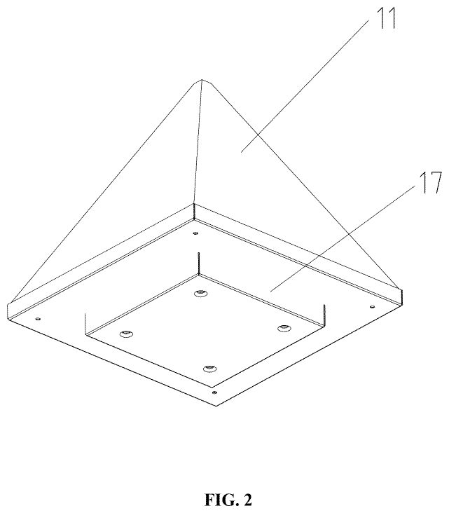

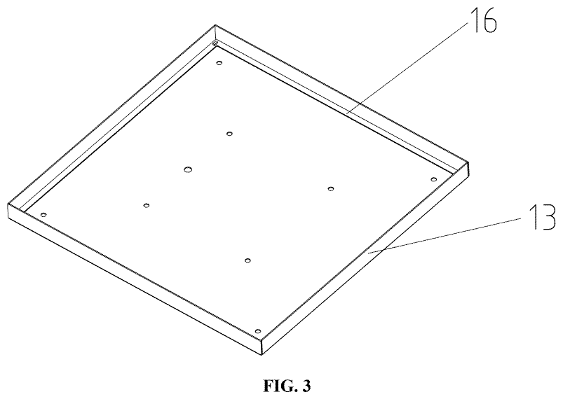

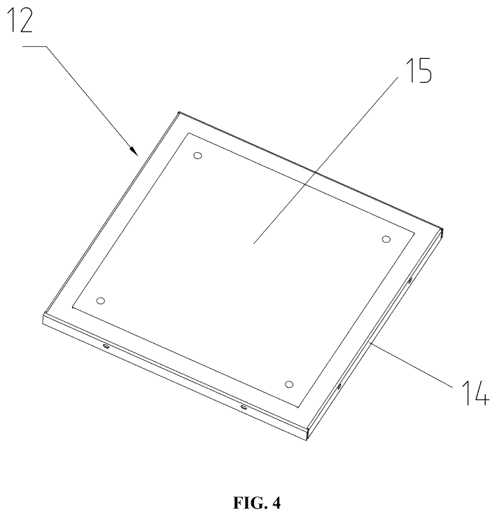

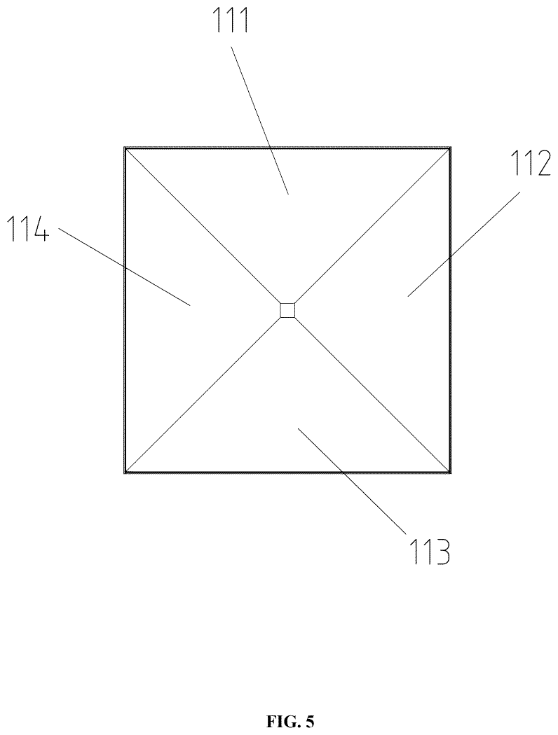

With reference to FIG. 1 to FIG. 6, a low-frequency red-light therapy lamp is provided. The low-frequency red-light therapy lamp includes a quadrangular pyramid 11 and a base fixedly connected to the quadrangular pyramid. The base is formed by embedding and connecting a first structural member 12 with a downward opening and a second structural member 13 with an upward opening, and the first structural member 12 is formed by splicing a third structural member 14 and a spiral PCB antenna board 15. An inner bottom circumference of the second structural member 13 is annularly provided with an LED string 16.

The quadrangular pyramid 11 includes a first side wall 111, a second side wall 112, a third side wall 113, and a fourth side wall 114. The first side wall 111, the second side wall 112, the third side wall 113, and the fourth side wall 114 are connected in pairs, and every two adjacent side walls are disposed at an included angle and encircle the quadrangular pyramid with a hollow interior and a quadrangular top; where the first side wall 111, the second side wall 112, the third side wall 113, and the fourth side wall 114 are all approximately trapezoidal and are made of an acrylic transparent material, and linear grooves are carved on each side wall.

In this embodiment of the present disclosure, a spiral PCB antenna board is embedded in the base, where the spiral PCB antenna board is configured to generate and transmit low-frequency electromagnetic waves. An inner bottom circumference of the second structural member is annularly provided with an LED string. When the LED string is on, light is irradiated from a bottom edge of the quadrangular pyramid, and a refraction effect is generated when light passes through the groove carved on the quadrangular pyramid.

In this embodiment, the spiral PCB antenna board is embedded in the base, where the spiral PCB antenna board is configured to generate and transmit low-frequency electromagnetic waves. The low-frequency electromagnetic waves and terrestrial magnetism affect sleep through mechanisms such as frequency synchronization, melatonin secretion, heart rate variability, and circadian rhythm anchoring. In addition, the frequency of the low-frequency electromagnetic waves is close to that of α/θ waves of a brain, which can promote sleep and deep sleep of a user and reduces night awakening. In addition, light is irradiated from a bottom edge of the quadrangular pyramid by using the LED string, and a refraction effect is generated when light passes through the carved grooves on the quadrangular pyramid, so that a stereo linear light source is presented, the whole light source of the therapy lamp is balanced and protrudes in an environment in which the whole light source is located, and a dazzling degree of a point light source for visual sensation is weakened.

In a specific embodiment, a single-chip microcomputer, an amplifier, and a spiral antenna are disposed in the spiral PCB antenna board, where the single-chip microcomputer is configured to generate electromagnetic waves, the amplifier is configured to amplify the electromagnetic waves, and the spiral antenna is configured to transmit the electromagnetic waves amplified by the amplifier.

It should be noted that a frequency of the low-frequency electromagnetic waves generated by the single-chip microcomputer may be 7.83 Hz, and the frequency of the electromagnetic waves generated by the single-chip microcomputer may also be designed based on actual requirements, which is not specifically limited herein.

In an implementation of the present disclosure, Schumann waves with a frequency of 7.83 Hz and terrestrial magnetism affect sleep through mechanisms such as frequency synchronization, melatonin secretion, heart rate variability, and circadian rhythm anchoring. Urban electromagnetic pollution and shielding may weaken synergistic effects thereof, and grounding and simulation of the Schumann waves can improve sleep. The frequency of the electromagnetic waves with the frequency of 7.83 Hz overlaps that of the α/θ waves in the brain, thereby facilitating sleep and deep sleep, and reducing night awakening. Moreover, the stable Schumann waves and terrestrial magnetism support night melatonin secretion and reduce cortisol, thereby improving a sleep structure.

Referring to FIG. 1, in a specific embodiment, the second structural member 13 includes a second cuboid with an upward opening, the third structural member 14 includes a first cuboid with a downward opening and a circular hollow hole in a top; and a cross-sectional area size of the second cuboid is greater than that of the first cuboid.

In this embodiment of the present disclosure, the cross-sectional area size of the second cuboid is greater than that of the first cuboid, so the third structural member may be embedded into the second structural member may be embedded into the second member, so that the third structural member is packaged in the base.

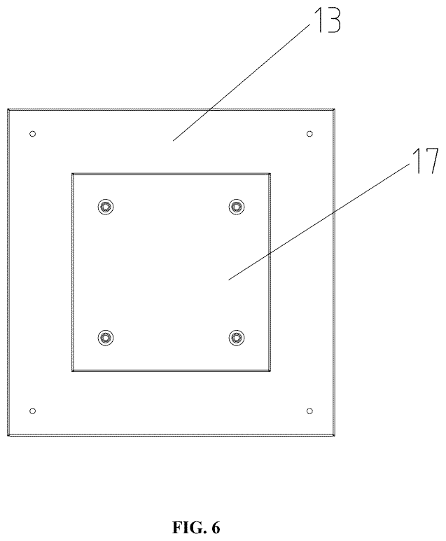

Referring to FIG. 1 and FIG. 6, in a specific embodiment, a fourth structural member 17 is further fixedly disposed at an outer bottom of the second structural member 13; and the fourth structural member 17 includes a third cuboid with an upward opening, where a cross-sectional area size of the third cuboid is less than a size of the first cuboid.

In this embodiment of the present disclosure, the fourth structural member 17 is disposed at the outer bottom of the second structural member 13 and a size of the fourth structural member 17 is less than that of the second structural member, so that the second structural member provided with the LED string can be separated from the ground or a table top, thereby facilitating heat dissipation.

In an embodiment of the present disclosure, a wavelength range of a luminescence spectrum of the LED string is 620 nm to 750 nm.

It should be noted that red light between 620 nm and 750 nm does not inhibit melatonin secretion, and has relatively low interference to melatonin. Melanin in a retina has highest sensitivity to short-wave blue light, and blue light inhibits melatonin secretion of a pineal body. However, a red light wavelength is relatively long, and hardly triggers this suppression mechanism, and a red light contact before bedtime does not disturb a sleep signal. A suitable amount of red light can be used as a weak light stimulus to help anchor a boundary of a circadian rhythm in the evening or early morning when used at low intensity. Low-intensity red light in the early morning can gently awaken the body and gradually adjust the rhythm. Therefore, red light can reduce brain excitement, thereby indirectly improving sleep efficiency.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A low-frequency red-light therapy lamp, wherein the therapy lamp comprises a quadrangular pyramid and a base fixedly connected to the quadrangular pyramid; the base is formed by embedding and connecting a first structural member with a downward opening and a second structural member with an upward opening, and the first structural member is formed by splicing a third structural member and a spiral PCB antenna board; an inner bottom circumference of the second structural member is annularly provided with an LED string;
the quadrangular pyramid comprises a first side wall, a second side wall, a third side wall, and a fourth side wall; the first side wall, the second side wall, the third side wall, and the fourth side wall are connected in pairs, and every two adjacent side walls are disposed at an included angle and encircle the quadrangular pyramid with a hollow interior and a quadrangular top; and linear grooves are carved on the first side wall, the second side wall, the third side wall, and the fourth side wall.

2. The low-frequency red-light therapy lamp according to claim 1, wherein a single-chip microcomputer, an amplifier, and a spiral antenna are disposed in the spiral PCB antenna board; and the single-chip microcomputer is configured to generate electromagnetic waves, the amplifier is configured to amplify the electromagnetic waves, and the spiral antenna is configured to transmit the electromagnetic waves.

3. The low-frequency red-light therapy lamp according to claim 1, wherein the third structural member comprises a first cuboid with a downward opening and a circular hollow hole in a top; and the second structural member comprises a second cuboid with an upward opening.

4. The low-frequency red-light therapy lamp according to claim 3, wherein a cross-sectional area size of the first cuboid is less than that of the second cuboid.

5. The low-frequency red-light therapy lamp according to claim 2, wherein a fourth structural member is further fixedly disposed at an outer bottom of the second structural member; and the fourth structural member comprises a third cuboid with an upward opening.

6. The low-frequency red-light therapy lamp according to claim 5, wherein a cross-sectional area size of the third cuboid is less than that of the second cuboid.

7. The low-frequency red-light therapy lamp according to claim 1, wherein a wavelength range of a luminescence spectrum of the LED string is 620 nm to 750 nm.
